(19) United States
(12) Patent Application Publication
(10) Pub. No.: US 2026/0278043 A1
(43) Pub. Date: Sep. 17, 2026

(54) SYSTEM AND METHOD FOR FILTERING REPRODUCED COMMUNICATION IN REAL-TIME

(71) Applicant: Wipro Limited, Bangalore (IN)

(72) Inventors: Gopichand AGNIHOTRAM, Bangalore (IN); Joydeep SARKAR, Kolkata (IN); Venkatesh BALASUBRAMANIAM, Pune (IN)

(73) Assignee: Wipro Limited, Bangalore (IN)

(21) Appl. No.: 19/222,712

(22) Filed: May 29, 2025

(30) Foreign Application Priority Data
Mar. 11, 2025 (IN) 202541022045

(51) Int. Cl. G06F 18/25

(52) U.S. Cl. CPC G06F 18/254; G06F 18/253

(57) ABSTRACT

A system and method for filtering reproduced communication in real-time is disclosed. A processor determines a plurality of data vectors associated with a communication input received via a user device. A set of spectrograms corresponding to a first set of data vectors are determined. A fused vector is determined from a second set of data vectors. A first confidence score is determined based on an analysis of the set of spectrograms. A second confidence score is determined based on an analysis of the fused vector. A weighted confidence score is determined based on the first confidence score, the second confidence score and corresponding predefined weights. The communication input is classified as one of a plurality of communication types based on the weighted confidence score and a set of predefined thresholds. The communication input received by the user device is filtered based on the classification.

### TECHNICAL FIELD

This disclosure relates generally to the field of authentication of reproduced communication, and more specifically to a system and method for filtering reproduced communication in real-time.

### BACKGROUND

In today's digital world, voice communication plays an important role in both professional and personal interactions. Businesses, financial institutions, and government agencies rely on voice-based authentication and communication systems for secure transactions, customer support, and identity verification. However, with advancements in artificial intelligence (AI) and deep learning, cybercriminals have developed sophisticated techniques to manipulate voice recordings and create highly realistic fake voices. These fake voices can imitate speech patterns, tone, and emotional expressions, of an individual and make it increasingly difficult to distinguish between real and artificially generated audio.

The rise of fake voice technology has introduced significant security threats, particularly in industries that depend on voice authentication and communication. Fraudsters can exploit these synthetic voices to mimic individuals in phone-based transactions, manipulate executives in business communication, or trick customer service representatives into granting unauthorized access to the sensitive information. This type of voice fraud can lead to financial losses, data breaches, and reputational damage for organizations.

Existing voice authentication and fraud detection methods may struggle to address this emerging challenge. Most existing methods rely solely on signal processing techniques or basic machine learning models that analyse speech patterns. Existing methods may not be able to accurately detect fake or mimicked voice and may also lack real-time detection capabilities.

Therefore, there is a need for a methodology for filtering reproduced communication in real-time.

### SUMMARY OF THE INVENTION

In an embodiment, a system for filtering reproduced communication in real time is disclosed. The system may include a processor, and a memory communicably coupled to the processor, wherein the memory stores processor-executable instructions, which when executed by the processor, cause the processor to determine a plurality of data vectors associated with a communication input received via a user device. The processor may further determine a set of spectrograms corresponding to a first set of data vectors from the plurality of data vectors. The processor may further determine a fused vector from a second set of data vectors from the plurality of data vectors using a vector fusing technique. The processor may further determine a first confidence score based on an analysis of the set of spectrograms using a vision transformer model. The processor may further determine a second confidence score based on an analysis of the fused vector using a deep learning classification model. The processor may further determine a weighted confidence score based on the first confidence score, the second confidence score and corresponding predefined weights associated to the first confidence score and the second confidence score. The processor may further classify the communication input as one of a plurality of communication types based on the weighted confidence score and a set of predefined thresholds. The processor may further filter the communication input received by the user device based on the classification.

In another embodiment, a method of filtering reproduced communication in real-time is disclosed. The method may include determining, by a processor and in real-time, a plurality of data vectors associated with a communication input received via a user device. The method may further include determining, by the processor, a set of spectrograms corresponding to a first set of data vectors from the plurality of data vectors. The method may further include determining, by the processor, a fused vector from a second set of data vectors from the plurality of data vectors using a vector fusing technique. The method may further include determining, by the processor, a first confidence score based on an analysis of the set of spectrograms using a vision transformer model. The method may further include determining, by the processor, a second confidence score based on an analysis of the fused vector using a deep learning classification model. The method may further include determining, by the processor, a weighted confidence score based on the first confidence score, the second confidence score and corresponding predefined weights associated to the first confidence score and the second confidence score. The method may further include classifying, by the processor, the communication input as one of a plurality of communication types based on the weighted confidence score and a set of predefined thresholds. The method may further include filtering, by the processor, the communication input received by the user device based on the classification.

In another embodiment, a non-transitory computer-readable medium storing computer-executable instructions for filtering reproduced communication in real-time is disclosed. The computer-executable instructions may be configured for determining, in real-time, a plurality of data vectors associated with a communication input received via a user device. The computer-executable instructions may be further configured for determining a set of spectrograms corresponding to a first set of data vectors from the plurality of data vectors. The computer-executable instructions may be further configured for determining a fused vector from a second set of data vectors from the plurality of data vectors using a vector fusing technique. The computer-executable instructions may be further configured for determining a first confidence score based on an analysis of the set of spectrograms using a vision transformer model. The computer-executable instructions may be further configured for determining a second confidence score based on an analysis of the fused vector using a deep learning classification model. The computer-executable instructions may be further configured for determining a weighted confidence score based on the first confidence score, the second confidence score and corresponding predefined weights associated to the first confidence score and the second confidence score. The computer-executable instructions may be further configured for classifying the communication input as one of a plurality of communication types based on the weighted confidence score and a set of predefined thresholds. The computer-executable instructions may be further configured for filtering the communication input received by the user device based on the classification.

It is to be understood that both the foregoing general description and the following detailed description are exemplary and explanatory only and are not restrictive of the invention, as claimed.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1 is a block diagram of an exemplary system for filtering reproduced communication in real-time, in accordance with an embodiment of the present disclosure.

FIG. 2 is a schematic diagram of a computing device of the system of FIG. 1, in accordance with an embodiment of the present disclosure.

FIG. 3 depicts an exemplary architecture diagram of a vision transformer model, in accordance with an embodiment of the present disclosure.

FIG. 4 depicts an exemplary architecture diagram of a deep learning classification model, in accordance with an embodiment of the present disclosure.

FIG. 5 depicts an exemplary schematic illustration representing determination of a weighted confidence score, in accordance with an embodiment of the present disclosure.

FIG. 6 is a flow diagram of a methodology of filtering reproduced communication in real-time, in accordance with an embodiment of present disclosure.

FIG. 7 is a flow diagram of a methodology of determining a fused vector, in accordance with an embodiment of present disclosure.

FIG. 8 is a flow diagram of a methodology of classifying communication input as one of a plurality of communication types, in accordance with an embodiment of present disclosure.

FIG. 9 is a flow diagram of a methodology of training a vision transformation model and a deep learning classification model, in accordance with an embodiment of the present disclosure.

FIG. 10 is an exemplary computing system that may be employed to implement processing functionality for various embodiments (e.g., as a SIMD device, client device, server device, one or more processors, or the like), in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

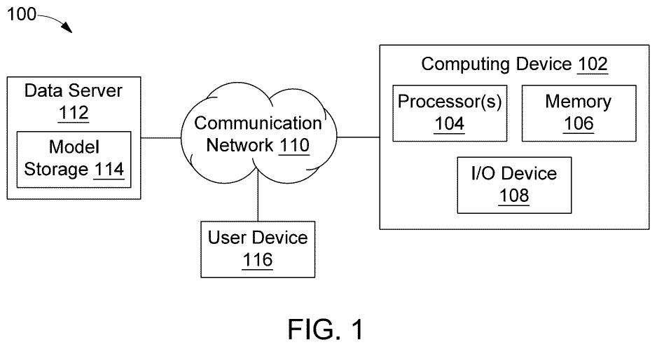

Referring now to FIG. 1 is a block diagram of an exemplary system 100 for filtering reproduced communication in real-time, is illustrated, in accordance with an embodiment of the present disclosure. The system 100 may include a computing device 102, a data server 112, and a user device 116 communicably coupled to each other through a wired or wireless communication network 110. The computing device 102 may include a processor 104, a memory 106 and an input/output (I/O) device 108.

In an embodiment, processor(s) 104 may include but are not limited to, microcontrollers, microprocessors, digital signal processors (DSPs), application-specific integrated circuits (ASICs), field-programmable gate arrays (FPGAs), system-on-chip (SoC) components, or any other suitable programmable logic devices. Examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™, system on a chip processors or other future processors.

In an embodiment, the memory 106 may store instructions that, when executed by the processor 104, and cause the processor 104 to filter reproduced communication in real-time, as will be discussed in greater detail herein below. In an embodiment, the memory 106 may be a non-volatile memory or a volatile memory. In an embodiment, the memory 106 may also store a single module or a combination of different modules to filter reproduced communication in real-time. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may comprise of variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the data server 112 may be enabled in a remote cloud server or a co-located server and may include a model storage 114 to store data necessary for the system 100 such as but not limited to trained classification models. In an embodiment, the data server 112 may store data input by the user device 116 such as communication input samples reference spectrogram datasets, confidence threshold parameters, and the like or output generated by the computing device 102 including classification results, weighted confidence scores, detected anomalies, and filtering actions applied to communication inputs. In an embodiment, the computing device 102 may be communicably coupled with the data server 112 through the communication network 110.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), or a Metropolitan Area Network (MAN). Various devices in the system 100 may be configured to connect to the communication network 110, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols. Further the communication network 110 can include a variety of network devices, including routers, bridges, servers, computing devices, storage devices, and the like.

In an embodiment, the computing device 102 and the user device 116 may be a computing system, including but not limited to, a laptop computer, a desktop computer, a notebook, a workstation, a server, a portable computer, a handheld or a mobile device. In an embodiment, the computing device 102 may be, but not limited to, in-built into the user device 116 or may be a standalone computing device. In an embodiment, the computing device 102 may perform various processing in order to filter reproduced communication in real-time.

By way of an example, the computing device 102 may receive a communication input. In an embodiment, the communication input may be indicated or provided by a user via the user device 116. In an embodiment, the communication input may include real-time audio or video data received from the user device 116. The computing device 102 may further determine a plurality of data vectors associated with the communication input. In an embodiment, the plurality of data vectors may correspond to a set of voice features, a set of text features, a set of emotional features and a set of image features. In an embodiment, the set of voice features may be determined based on Mel-frequency cepstral coefficients (MFCCs) of the communication input. In an embodiment, the set of text features may be determined based on conversion of audio information of the communication input to text information. In an embodiment, the set of text features may include semantic information and linguistic information determined from the text information. In an embodiment, the emotional features may be determined based on the set of text features. In an embodiment, the image features may be determined based on determination of a spectrogram representation of the set of voice features.

The computing device 102 may further determine a set of spectrograms corresponding to a first set of data vectors from the plurality of data vectors. The computing device 102 may further determine a fused vector from a second set of data vectors from the plurality of data vectors using a vector fusion technique. The computing device 102, in order to determine the fused vector, may determine a highest length of data vector in the second set of data vectors. The computing device 102, in order to determine the fused vector, may determine a third set of data vectors by altering lengths of each of the second set of data vectors equal to the highest length by using a padding technique. The computing device 102, in order to determine the fused vector, may add the third set of data vectors to determine the fused vector.

The computing device 102 may further determine a first confidence score based on an analysis of the set of spectrograms using a vision transformer model. In an embodiment, the vision transformer model may be trained based on a training set of spectrograms corresponding to a set of training communication inputs of each of a plurality of communication types.

The computing device 102 may further determine a second confidence score based on an analysis of the fused vector using a deep learning classification model. In an embodiment, the deep learning classification model may be a Long Short-Term Memory (LSTM) with multi-head attention model. In an embodiment, the deep learning classification model may be trained based on a training set of fused vectors corresponding to the set of training communication inputs of each of the plurality of communication types.

The computing device 102 may further determine a weighted confidence score based on the first confidence score, the second confidence score and corresponding predefined weights associated to the first confidence score and the second confidence score. The computing device 102 may further classify the communication input as one of the plurality of communication types based on the weighted confidence score and a set of predefined thresholds. In an embodiment, the plurality of communication types may include a real communication type, a fake communication type, and a mimicked communication type. In an embodiment, the communication input may be classified as the fake communication type in case the weighted confidence score may be equal to or greater than a first threshold level from the set of predefined thresholds. In an embodiment, the communication input may be classified as the mimicked communication type in case the weighted confidence score may be less than the first threshold level and greater than a second threshold level from the set of predefined thresholds.

In order to classify the communication input as the mimicked communication type, upon determining the weighted confidence score less than the first threshold level and greater than the second threshold level, the computing device 102 may determine a similarity score based on comparison between the set of spectrograms and a set of reference spectrograms of reference communication samples classified as the real communication type. In an embodiment, the communication input may be classified as the mimicked communication type in case the similarity score may be determined above a predefined similarity threshold. In an embodiment, the communication input may be classified as the real communication type in case the weighted confidence score may be less than the second threshold level. The computing device 102 may further filter the communication input received by the user device 116 based on the classification.

In an embodiment, the disclosed system 100 may be implemented as a computer-readable medium (CRM) that stores executable instructions for filtering reproduced communication in real-time. The CRM may store non-transitory computer-readable instructions that, when executed by a processor (such as the processor 104), cause the system 100 to perform various operations described in the present disclosure so as to filter reproduced communication in real-time. The CRM may be any form of non-volatile memory, such as a flash memory, read-only memory (ROM), or an electrically erasable programmable read-only memory (EEPROM), configured to store data and executable instructions for performing code migration. The CRM may also contain modules for determining vectors, determining spectrograms, determining fused vector, training models, determining first confidence score, determining second confidence score, determining weighted confidence score, classifying communication input, and filtering communication input.

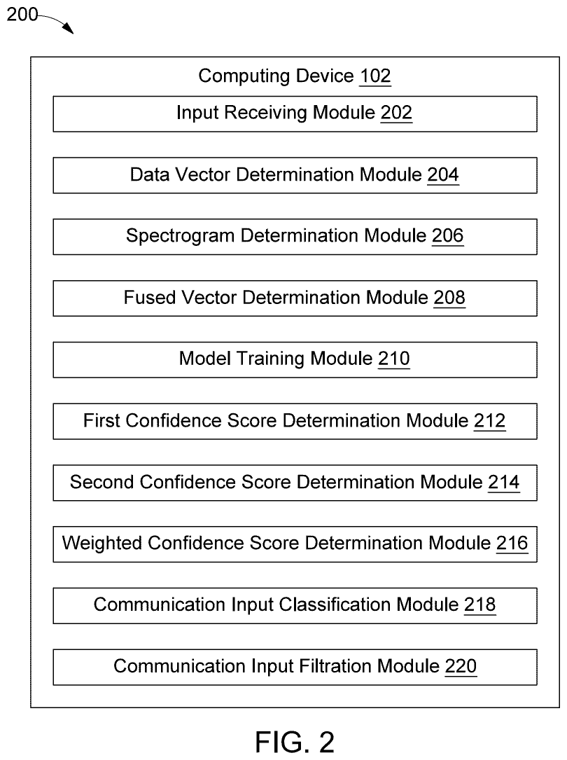

Referring now to FIG. 2, a schematic diagram 200 of the computing device 102 of the system of FIG. 1, is illustrated, in accordance with an embodiment of the present disclosure. In an embodiment, the computing device 102 may include an input receiving module 202, a data vector determination module 204, a spectrogram determination module 206, a fused vector determination module 208, a model training module 210, a first confidence score determination module 212, a second confidence score determination module 214, a weighted confidence score determination module 216, a communication input classification module 218, and a communication input filtration module 220.

The input receiving module 202 may receive a communication input. In an embodiment, the communication input may be indicated or provided by a user via the user device 116. In an embodiment, the communication input may include, but not limited to, real-time audio or video data received from the user device 116.

Further, the data vector determination module 204 may determine a plurality of data vectors associated with the communication input. In an embodiment, the plurality of data vectors may correspond to a set of voice features, a set of text features, a set of emotional features and a set of image features. In an embodiment, the set of voice features may be determined based on Mel-frequency cepstral coefficients (MFCCs) of the communication input. In an embodiment, the set of text features may be determined based on conversion of audio information of the communication input to text information. In an embodiment, the set of text features may include semantic information and linguistic information determined from the text information. In an embodiment, the emotional features may be determined based on the set of text features. In an embodiment, the image features may be determined based on determination of a spectrogram representation of the set of voice features.

In an embodiment, the set of voice features may be determined based on Mel-frequency cepstral coefficients (MFCCs) extracted from the communication input. The MFCCs may be computed using an audio feature extraction process involving pre-emphasis to amplify higher frequencies, framing and windowing to divide signal of the communication input into short overlapping segments, Fast Fourier Transform (FFT) to convert the communication input into the frequency domain, Mel filter bank processing to map the frequency spectrum to the Mel scale, logarithmic compression to reflect loudness perception, and Discrete Cosine Transform (DCT) to generate compact feature representations. Additionally, the set of voice features may include acoustic parameters such as delta coefficients, spectral flux, phase, and energy variations. These voice features may be converted into numerical feature vectors.

In an embodiment, the set of text features may be determined by converting the audio information of the communication input into text information using automatic speech recognition (ASR) techniques. The extracted text information may undergo pre-processing, including noise reduction, tokenization, and normalization, to enhance analysis. The set of text features may include semantic and linguistic information such as word frequency, sentence structure, syntactic dependencies, and contextual meaning derived from pre-trained language models. The set of text features may be transformed into numerical representations using encoding techniques like one-hot encoding, word embeddings (Word2Vec, BERT), or sentence embeddings (Sentence Transformer). These text-based feature vectors allow for intent recognition, sentiment analysis, and classification of speech patterns in order to assist in differentiating between real and fake-generated voices.

In an embodiment, the set of emotional features may be determined based on the set of text features extracted from the communication input. The emotional content of the communication input may be analyzed using lexical-based techniques, word embedding models, and domain-specific emotion classifiers. The emotional features may be derived using methods such as emotion lexicons, TF-IDF, dependency parsing, and sentence-level sentiment analysis to detect affective expressions within the communication input. Pre-trained transformer models like BERT-based emotion classifiers may be employed to analyse the probability distribution of emotions such as happiness, sadness, anger, or fear in the extracted set of text features.

In an embodiment, the set of image features may be determined based on spectrogram representation of the set of voice features. The spectrogram provides a visual representation of the frequency content of the communication input over time. The process of spectrogram generation includes segmenting the audio (i.e., communication input) into short overlapping frames, applying a window function such as Hamming or Hann to minimize spectral distortions, computing the Fast Fourier Transformation (FFT) to obtain frequency components, and applying a logarithmic transformation to enhance human perceptual alignment.

Thereafter, the spectrogram determination module 206 may determine a set of spectrograms corresponding to a first set of data vectors from the plurality of data vectors. In an embodiment, the first set of data vectors may correspond to the set of image features. In an embodiment, the set of spectrograms represent a visual transformation of the audio information of the communication input and depict the frequency content over time. To generate the set of spectrograms, the spectrogram determination module 206 may process the set of image features of the communication input by segmenting the audio into overlapping frames, applying a window function such as Hamming or Hann to minimize spectral leakage, and performing a Fast Fourier Transform (FFT) on each frame to obtain the frequency-domain representation of the audio. The magnitude spectrum is then converted to a logarithmic scale to align with human auditory perception, and the processed frequency information is mapped into a time-frequency representation, where the x-axis represents time, the y-axis represents frequency, and the intensity of each point corresponds to the amplitude of the audio at a specific frequency.

Further, the fused vector determination module 208 determine a fused vector from a second set of data vectors from the plurality of data vectors using a vector fusion technique. In an embodiment, the second set of data vectors may correspond to the set of voice features, the set of emotional features, and the set of text features. The fused vector determination module 208, in order to determine the fused vector, may determine a highest length of data vector in the second set of data vectors. Thereafter, the fused vector determination module 208, in order to determine the fused vector, may determine a third set of data vectors by altering lengths of each of the second set of data vectors equal to the highest length by using a padding technique. The fused vector determination module 208, in order to determine the fused vector, may add the third set of data vectors to determine the fused vector.

In an embodiment, the fused vector determination module 208 may determine the fused vector from the second set of data vectors extracted from the plurality of data vectors. In an embodiment, the second set of data vectors corresponds to the set of voice features, the set of emotional features, and the set of text features. Since these data vectors are derived from different modalities like audio, linguistic, and emotional analysis, they may have varying dimensions and formats. To ensure consistency in representation, the fused vector determination module 208 may employ a vector fusion technique that aligns the dimensions of these heterogeneous feature sets before combining them into a single vector representation.

In an embodiment, the fused vector determination module 208 may determine a highest length of data vector among the second set of data vectors. Since different data vectors may have different lengths depending on their feature extraction process (e.g., MFCC-based voice features, sentiment vectorized text features, and emotional embeddings), a padding technique may be applied to normalize their lengths. The padding technique may involve extending the shorter vectors with additional values, typically zeros, to match the length of the longest vector. This ensures that all data vectors have a uniform dimension, preventing loss of information during fusion. In an embodiment, the fused vector determination module 208 may determine the third set of data vectors to match the highest length. Once the dimensions are aligned, the fused vector determination module 208 may perform an element-wise addition of the third set of data vectors to compute the fused vector. The fused vector represents a comprehensive feature embedding, integrating the set of voice features, the set of text features, and the set of emotional features.

Further, the first confidence score determination module 212 may determine a first confidence score based on an analysis of the set of spectrograms using a vision transformer model. In an embodiment, the first confidence score may represent a probability measure indicating the likelihood that the communication input is fake or manipulated. In an embodiment, the first confidence score determination module 212 may process the set of spectrograms derived from the spectrogram determination module 206 and provide them as input to the vision transformer model. The vision transformer model analyses the set of spectrograms using a transformer-based attention mechanism, which enables the vision transformer model to capture complex patterns, spectral variations, and anomalies present in the frequency distribution of the communication input. By analyzing the visual structure of the spectrograms, the vision transformer model detects subtle inconsistencies or artifacts commonly associated with fake-generated or mimicked communication type. In an embodiment, the first confidence score determination module 212 may execute an inference operation using the vision transformer model to compute the first confidence score, which quantifies the probability of the spectrogram corresponding to a fake communication type.

The vision transformer model may be trained based on a training set of spectrograms corresponding to a set of training communication inputs of each of a plurality of communication types. In order to train the vision transformer model, the input receiving module 202 may receive a set of training communication inputs of each of the plurality of communication types. Further, in order to train the vision transformer model, the data vector determination module 204 may determine a plurality of training data vectors associated with a set of training communication inputs received via the user device 116. Thereafter, in order to train the vision transformer model, the spectrogram determination module 206, may determine a training set of spectrograms corresponding to a first set of training data vectors from the plurality of training data vectors. Further, in order to train the vision transformer model, the model training module 210 may train the vision transformer model based on the training set of spectrograms corresponding to the first set of training data vectors from the plurality of training data vectors corresponding to the set of training communication inputs.

In an exemplary embodiment, the vision transformer model may be trained based on the training set of spectrograms corresponding to the set of training communication inputs of each of the plurality of communication types. In order to train the vision transformer model, the input receiving module 202 may receive the set of training communication inputs. In an embodiment, the training data may include a plurality of labelled audio and/or video files categorized as either real, fake, or mimicked. The training data may be balanced to include diverse age groups, genders, and regional accents to enhance generalization across different voice patterns. The input receiving module 202 may extract the audio component from video-based training data to ensure uniformity in processing. In an embodiment, the data vector determination module 204 may determine the plurality of training data vectors associated with the set of training communication inputs. These training data vectors may include text features, voice features, emotional features, and image features derived from the set of training communication inputs. The text features may be determined through speech-to-text conversion, tokenization, and semantic analysis, whereas the voice features may be extracted using Mel-frequency cepstral coefficients (MFCCs), spectral flux, and phase variations. The emotional features may be derived from the text features using lexical emotion classification and transformer-based sentiment analysis models. In an embodiment, the spectrogram determination module 206 may generate the training set of spectrograms corresponding to the first set of training data vectors from the plurality of training data vectors. The training set of spectrograms may be generated by segmenting the audio information of the set of training communication inputs into short overlapping frames, applying a windowing function, and performing a Fast Fourier Transform (FFT) to obtain the time-frequency representation of the audio information. The magnitude spectrum may be converted to a logarithmic scale, and the training set of spectrograms may be constructed with time on the x-axis, frequency on the y-axis, and amplitude as colour intensity. These training set of spectrograms serve as image-based representations of the set of training communication inputs which enable the vision transformer model to capture distinctive spectral patterns associated with real, fake, or mimicked voices.

In an embodiment, the model training module 210 may train the vision transformer model using the training set of spectrograms corresponding to the first set of training data vectors. The training process may involve splitting each of the training set of spectrograms into smaller patches, which are then linearly embedded and passed through a multi-layer transformer architecture. A feature selection mechanism may iteratively drop and assess the importance of individual patches and identifying the most relevant spectral regions for classification. The model training module 210 may apply a categorical cross-entropy loss function to quantify the difference between predicted classifications and actual labels. The loss function may be used in backpropagation to enable the vision transformer model to optimize feature selection and improve classification accuracy. In an embodiment, the trained vision transformer model may learn to detect spectral inconsistencies, unnatural artifacts, and high-frequency distortions present in manipulated or synthesized voices. Upon completion of training, the model training module 210 may store the trained vision transformer model in the model storage 114.

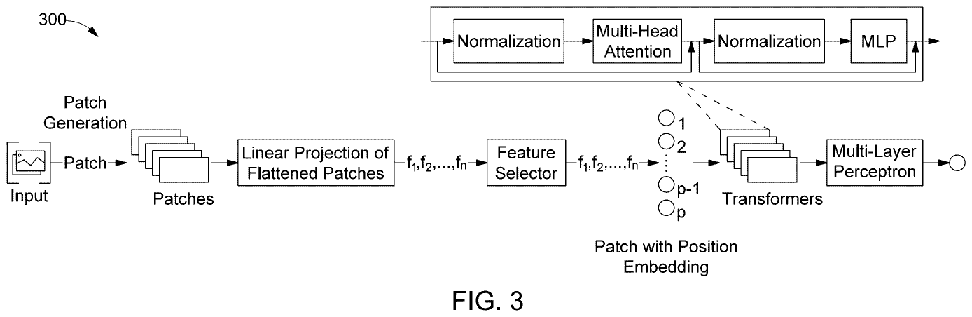

Referring now to FIG. 3, an exemplary architecture diagram 300 of the vision transformer model, is depicted, in accordance with an embodiment of the present disclosure. In an embodiment, the vision transformer model may process a training input image, such as a training spectrogram of a training communication input. The architecture may begin with a patch generation stage, where the training spectrogram is divided into smaller patches of equal size. These patches represent localized sections of the input image, allowing the vision transformer model to capture fine-grained spectral details present in the training communication input. In an embodiment, the generated patches are flattened and linearly projected into feature representations. The linear projection layer maps the patches into feature vectors that serve as input tokens for further processing. Thereafter, a feature selector processes these feature vectors to identify the most relevant features in order to optimize training efficiency and reducing computational overhead. The feature selector may utilize a categorical cross-entropy loss function to evaluate feature importance by iteratively removing patches and analyzing the impact on accuracy of the vision transformer model. Patches that contribute significantly to classification accuracy are retained, while others may be dropped. In an embodiment, the selected patches are embedded with positional information before being processed by the transformer layers. Each transformer layer consists of multiple components, including a normalization unit, a multi-head attention module, and a multi-layer perceptron (MLP). The normalization unit ensures numerical stability in the feature representations, while the multi-head attention module enables the vision transformer model to focus on multiple regions of the training input image simultaneously to capture contextual dependencies across different frequency components in the training spectrogram. The MLP module applies non-linear transformations to refine the learned representations.

In an embodiment, the processed feature embeddings from the transformer layers are passed through a final multi-layer perceptron (MLP) classifier, which generates a classification output. The classification output determines whether the training communication input corresponds to a real, fake, or mimicked voice. The loss function quantifies the difference between the predicted label and the ground truth label, and this error is backpropagated to the feature selector in order to ensure that the vision transformer model continuously refines its feature selection strategy during training. In an embodiment, once the vision transformer model has been trained, the final trained model is stored and used for real-time classification of real-time communication inputs.

Referring back to FIG. 2, the second confidence score determination module 214 may determine a second confidence score based on an analysis of the fused vector using a deep learning classification model. In an embodiment, the deep learning classification model may be a Long Short-Term Memory (LSTM) with multi-head attention model. In an embodiment, the second confidence score determination module 214 may process the fused vector, which integrates the set of text features, the set of emotional features, and the set of voice features extracted from the communication input. The fused vector serves as a comprehensive feature representation that captures sequential dependencies, contextual information, and acoustic patterns in the communication input. In an embodiment, the fused vector is provided as an input to a deep learning classification model, specifically an LSTM with a multi-head attention model. The LSTM model is designed to process sequential data which makes it well-suited for analyzing temporal dependencies in voice and linguistic features. The multi-head attention mechanism enhances the capability of the LTSM model by allowing it to focus on multiple important aspects of communication input. The multi-head attention mechanism simultaneously ensures that relevant patterns and anomalies within the fused vector are captured effectively. In an embodiment, the LSTM with multi-head attention model performs a prediction operation to compute the second confidence score, which quantifies the likelihood that the communication input corresponds to a fake communication type or a manipulated communication type.

The deep learning classification model may be trained based on a training set of fused vectors corresponding to the set of training communication inputs of each of the plurality of communication types. In order to train the deep learning classification model, the input receiving module 202 may receive a set of training communication inputs of each of the plurality of communication types. Further, in order to train the deep learning classification model, the data vector determination module 204 may determine a plurality of training data vectors associated with a set of training communication inputs received via the user device 116. Thereafter, in order to train the deep learning classification model, the fused vector determination module 208, may determine a training set of fused vectors from a second set of training data vectors from the plurality of training data vectors. Further, in order to train the deep learning classification model, the model training module 210 may train the deep learning classification model based on the training set of fused vectors from the second set of training data vectors from the plurality of training data vectors corresponding to the set of training communication inputs.

In an exemplary embodiment, the deep learning classification model may be trained based on the training set of fused vectors corresponding to the set of training communication inputs of each of a plurality of communication types. In order to train the deep learning classification model, the input receiving module 202 may receive the set of training communication inputs, including audio and/or video data labelled as either real, fake, or mimicked. These labelled inputs ensure that the deep learning classification model is trained with a balanced dataset that incorporate a range of voice samples across different age groups, genders, and regional accents to improve generalization. The input receiving module 202 may extract the audio component from video-based training inputs to ensure uniformity in processing. In an embodiment, the data vector determination module 204 may determine the plurality of training data vectors associated with the set of training communication inputs. These training data vectors may correspond to text features, voice features, and emotional features, extracted using speech-to-text conversion, acoustic signal processing, and sentiment analysis techniques, respectively. Each of these data vectors represents distinct modalities of information that collectively contribute to detecting inconsistencies in fake and mimicked voices. In an embodiment, the fused vector determination module 208 may determine the training set of fused vectors from the second set of training data vectors by merging the set of text features, the set of voice features, and the set of emotional features into a single comprehensive vector representation. To achieve uniformity in data dimensions, the fused vector determination module 208 may first determine the longest feature vector in the second set of training data vectors. The fused vector determination module 208 may then apply a padding technique to extend shorter vectors to match this length in order to ensure consistency across different input types. Finally, the aligned training data vectors are aggregated through element-wise addition, generating the fused training vectors, which serve as inputs to the deep learning classification model.

In an embodiment, the model training module 210 may train the deep learning classification model, specifically an LSTM with multi-head attention model, using the training set of fused vectors. The LSTM layers process the sequential nature of voice and linguistic data, ensuring that the model learns temporal dependencies across different speech features. A multi-head attention mechanism is applied to allow the LTSM model to focus on multiple relevant aspects of the fused vectors. The multi-head attention mechanism may simultaneously identify salient features that contribute to classification accuracy. In an embodiment, the training process may include feature selection and dynamic weight allocation to optimize the learning efficiency of the LTSM model. A feature selector within the LTSM model may assess the contribution of individual features by iteratively removing features and evaluating the impact on classification accuracy. The most critical features are retained, while less relevant features are dropped to prevent overfitting. Additionally, a weight allocator may assign higher weights dynamically to the most relevant features, adjusting the LTSM model focus in real-time to improve classification performance. In an embodiment, once the deep learning classification model (i.e., LTSM model) is fully trained, the trained model is stored in the model storage 114 for deployment in a real-time filtering of reproduced communication.

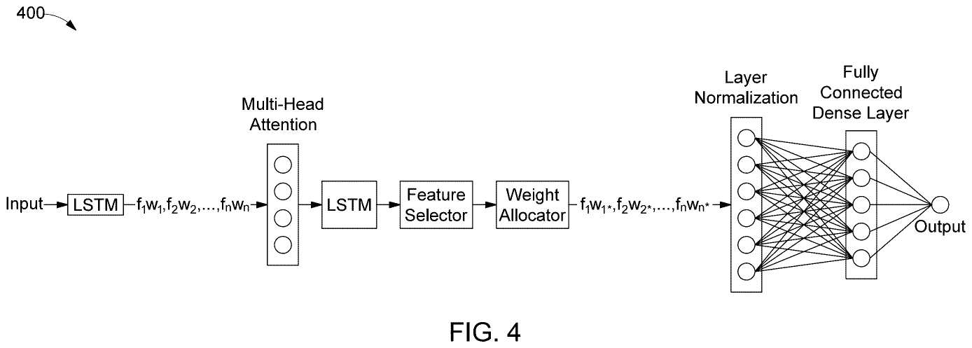

Referring now to FIG. 4, an exemplary architecture diagram 400 of a deep learning classification model, is depicted, in accordance with an embodiment of the present disclosure. In an embodiment, the deep learning classification model processes the set of training fused vectors consisting of the set of text features, the set of voice features, and the set of emotional features extracted from the set of training communication inputs. The deep learning classification model utilizes a Long Short-Term Memory (LSTM) network with multi-head attention to effectively capture the sequential dependencies and contextual significance of these features. In an embodiment, the input layer receives the set of training fused vectors and feeds it into an LSTM layer, which retains temporal dependencies within the sequential data. The LSTM layer processes the input sequence while maintaining its structural integrity which ensure that relevant contextual details of the voice, linguistic, and emotional features are preserved throughout the learning process of the LSTM model. In an embodiment, the output of the LSTM layer is passed through a multi-head attention module, which allows the LSTM model to focus on multiple important aspects of the input data simultaneously. The multi-head attention mechanism enhances feature discrimination by assigning varying levels of attention to different portions of the input sequence, thereby improving classification performance. The attention-weighted features are subsequently processed by a second LSTM layer, ensuring that the LSTM model effectively aggregates relevant information across time while filtering out irrelevant or redundant patterns.

In an embodiment, the feature selector dynamically selects the most informative features by iteratively evaluating their contribution to classification accuracy. The feature selector removes less relevant features while retaining those with higher predictive significance, thereby optimizing efficiency of the LSTM model. Once the relevant features are selected, the weight allocator dynamically assigns higher weights to the most significant features, ensuring that the deep learning classification model prioritizes key voice, text, and emotional markers that contribute to accurate identification of fake or mimicked voices. In an embodiment, the normalized and weighted feature representations are then passed through a layer normalization module, which stabilizes the learning process by reducing internal covariate shifts. This ensures consistent training and prevents overfitting. The fully connected dense layer applies non-linear transformations to further refine feature representations before producing the final classification output. In an embodiment, the final output layer utilizes a SoftMax activation function, which generates a probability distribution over two classification labels such as “Real” or “Fake”. The classification decision is based on the probability scores, with the highest confidence score determining whether the training communication input is a fake, mimicked, or real voice. In an embodiment, the LSTM model is trained using a backpropagation process, where the loss function is computed based on the difference between the predicted classification and the actual label. The computed loss value is propagated back to the feature selector and the weight allocator, allowing the LSTM model to iteratively refine its feature importance assessment and weight assignments. Upon successful training, the trained LSTM with multi-head attention model is stored in the model storage 114.

Referring back to FIG. 2, the weighted confidence score determination module 216 may determine a weighted confidence score based on the first confidence score, the second confidence score, and corresponding predefined weights associated to the first confidence score and the second confidence score. In an embodiment, the weighted confidence score determination module 216 may aggregate outputs from multiple models to enhance the accuracy and reliability of fake voice detection. Specifically, the weighted confidence score determination module 216 receives the first confidence score from the vision transformer model, which determines the likelihood of the input being fake based on spectrogram analysis, and the second confidence score from the LSTM with Multi-head Attention Classification model, which evaluates the fused vector of text, voice, and emotional features. In an embodiment, the weighted confidence score determination module 216 applies predefined weights to both confidence scores to compute an aggregated weighted confidence score. The weighting mechanism ensures that the classification contributions of both models are proportionally balanced based on their importance in detecting cloned or mimicked voices. For example, a 2:3 weight ratio may be assigned, giving higher priority to the LSTM with Multi-head Attention Model due to its ability to analyse multiple input types comprehensively. In an embodiment, the module calculates a weighted sum (WS) of the first and second confidence scores using a weighted averaging technique. The computed weighted confidence score is then compared with predefined classification thresholds to determine whether the communication input is real, cloned, or mimicked.

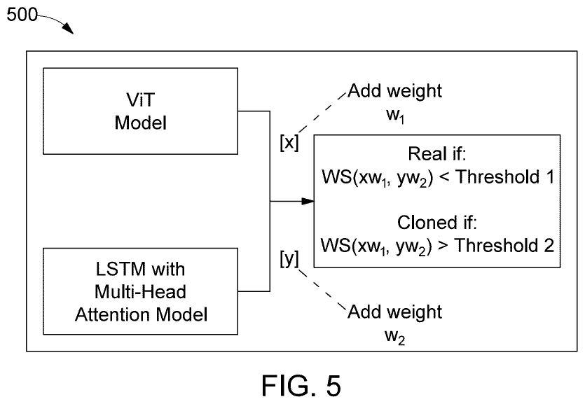

Referring now to FIG. 5, an exemplary schematic illustration 500 representing determination of a weighted confidence score, in accordance with an embodiment of the present disclosure. In an embodiment, the weighted confidence score determination process is executed by the weighted confidence score determination module 216, which aggregates classification results from multiple models to improve the accuracy and reliability of fake and mimicked voice detection. The weighted confidence score determination module 216 receives two confidence scores as inputs such as the first confidence score (x) from the vision transformer model, which evaluates the spectrogram of the communication input to determine the likelihood of it being fake and the second confidence score (y) from the LSTM with Multi-head Attention model, which analyses the fused vector of voice, text, and emotional features to compute another likelihood score. In an embodiment, the weighted confidence score determination module 216 assigns predefined weights (w1 and w2) to the first confidence score and the second confidence score based on their relative importance in the classification process. Since the LSTM with Multi-head Attention Model processes multiple input types, it is assigned a higher weight than the vision transformer model. For instance, a 2:3 weight ratio may be applied to balance the influence of both models. The Ensemble Unit then computes a Weighted Sum (WS) by performing a weighted average of the first confidence score and the second confidence score, which results in a final weighted confidence score.

Referring back to FIG. 2, the communication input classification module 218 may classify the communication input as one of the plurality of communication types based on the weighted confidence score and a set of predefined thresholds. In an embodiment, the plurality of communication types may include a real communication type, a fake communication type, and a mimicked communication type. In an embodiment, the communication input may be classified as the fake communication type in case the weighted confidence score may be equal to or greater than a first threshold level from the set of predefined thresholds. In an embodiment, the communication input may be classified as the mimicked communication type in case the weighted confidence score may be less than the first threshold level and greater than a second threshold level from the set of predefined thresholds.

In order to classify the communication input as the mimicked communication input, upon determining the weighted confidence score less than the first threshold level and greater than the second threshold level, the communication input classification module 218 may determine a similarity score based on comparison between the set of spectrograms and a set of reference spectrograms of reference communication samples classified as the real communication type. In an embodiment, the communication input may be classified as the mimicked communication type in case the similarity score may be determined above a predefined similarity threshold. In an embodiment, the communication input may be classified as the real communication type in case the weighted confidence score may be less than the second threshold level.

In an embodiment, If the weighted confidence score is below the second threshold level (e.g., less than 0.45), the communication input classification module 218 classifies the communication input as real and forwards the result to the user device 116. If the weighted confidence score is equal to or above the first threshold level (e.g., greater than 0.60), the communication input classification module 218 classifies the communication input as cloned (fake) and sends the result to the user device 116. If the weighted confidence score falls between the second threshold level and the first threshold level (e.g., between 0.45 and 0.60) for example, the weighted confidence score is less than the first threshold level and greater than the second threshold level, the communication input classification module 218 performs an additional verification step by comparing the input spectrogram with reference spectrograms of real voices. In an embodiment, the communication input classification module 218 analyses the spectrogram similarity to determine whether the input corresponds to a mimicked voice.

Further, the communication input filtration module 220 may filter the communication input received by the user device based on the classification. In an embodiment, the communication input filtration module 220 processes the final classification result provided by the communication input classification module 218 to determine the appropriate filtering action for the received communication input. Based on the classification of the communication input as the real communication type, the fake communication type, or the mimicked communication type, the filtration module 220 applies specific filtering rules to mitigate the risk of fraudulent or unauthorized communications. In an embodiment, if the communication input is classified as the real communication type, the filtration module 220 allows the input to be processed without restrictions to ensure that genuine communications are not disrupted. The real communication is then forwarded to the intended recipient or application via the user device 116. If the communication input is classified as the cloned or fake communication type, the filtration module 220 blocks or flags the communication input in order to prevent it from being processed further. In certain implementations, the filtration module 220 may trigger an alert or notification to inform the user or an administrative system about the presence of a fake voice or video input. Additionally, the filtration module 220 may log the fraudulent attempt for further analysis, regulatory compliance, or forensic investigation. In an embodiment, if the communication input is classified as the mimicked communication, the filtration module 220 may apply a secondary validation step, such as requesting additional identity verification from the user or comparing historical voice patterns to assess the likelihood of deception. In some implementations, the filtration module 220 may partially restrict the communication, allowing it to pass through with a warning flag, or it may escalate the decision to an external authentication system for further scrutiny.

It should be noted that all such aforementioned modules 202-220 may be represented as a single module or a combination of different modules. Further, as will be appreciated by those skilled in the art, each of the modules 202-220 may reside, in whole or in parts, on one device or multiple devices in communication with each other. In some embodiments, each of the modules 202-220 may be implemented as dedicated hardware circuit comprising custom application-specific integrated circuit (ASIC) or gate arrays, off-the-shelf semiconductors such as logic chips, transistors, or other discrete components. Each of the modules 202-220 may also be implemented in a programmable hardware device such as a field programmable gate array (FGPA), programmable array logic, programmable logic device, and so forth. Alternatively, each of the modules 202-220 may be implemented in software for execution by various types of processors (e.g. processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for filtering reproduced communication in real-time. For example, the exemplary system 100 and the associated computing device 102 may filter reproduced communication in real-time by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

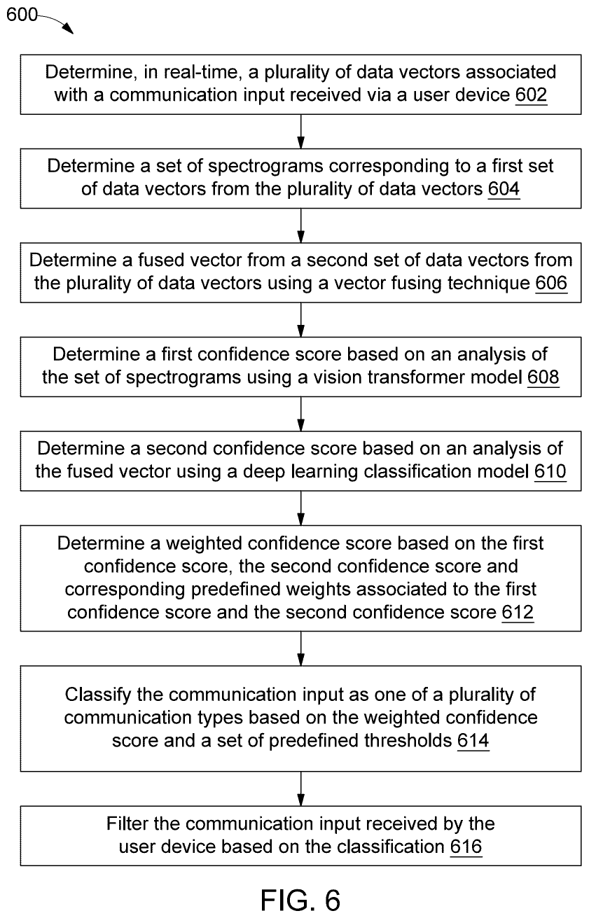

Referring now to FIG. 6, a flow diagram 600 of a methodology of filtering reproduced communication in real-time, is illustrated, in accordance with an embodiment of the present disclosure. FIG. 6 is explained in conjunction with FIGS. 1-5. In an embodiment, the flow diagram 600 may include a plurality of steps that may be performed by various modules of the computing device 102 so as to filter reproduced communication in real-time.

At step 602, a plurality of data vectors associated with a communication input may be determined. In an embodiment, the communication input may be indicated or provided by a user via the user device 116. In an embodiment, the plurality of data vectors may correspond to a set of voice features, a set of text features, a set of emotional features and a set of image features. In an embodiment, the set of voice features may be determined based on Mel-frequency cepstral coefficients (MFCCs) of the communication input. In an embodiment, the set of text features may be determined based on conversion of audio information of the communication input to text information. In an embodiment, the set of text features may include semantic information and linguistic information determined from the text information. In an embodiment, the emotional features may be determined based on the set of text features. In an embodiment, the image features may be determined based on determination of a spectrogram representation of the set of voice features.

Further at step 604, a set of spectrograms corresponding to a first set of data vectors may be determined from the plurality of data vectors. Further at step 606, a fused vector may be determined from a second set of data vectors from the plurality of data vectors using a vector fusion technique.

Further at step 608, a first confidence score may be determined based on an analysis of the set of spectrograms using a vision transformer model. In an embodiment, the vision transformer model may be trained based on a training set of spectrograms corresponding to a set of training communication inputs of each of a plurality of communication types.

Further at step 610, a second confidence score may be determined based on an analysis of the fused vector using a deep learning classification model. In an embodiment, the deep learning classification model may be trained based on a training set of fused vectors corresponding to the set of training communication inputs of each of the plurality of communication types.

Further at step 612, a weighted confidence score may be determined based on the first confidence score, the second confidence score and corresponding predefined weights associated to the first confidence score and corresponding predefined weights associated to the first confidence score and the second confidence score.

Further at step 614, the communication input may be classified as one of the plurality of communication types based on the weighted confidence score and a set of predefined thresholds. In an embodiment, the plurality of communication types may include a real communication type, a fake communication type, and a mimicked communication type. Further at step 616, the communication input received by the user device 116 may be filtered based on the classification.

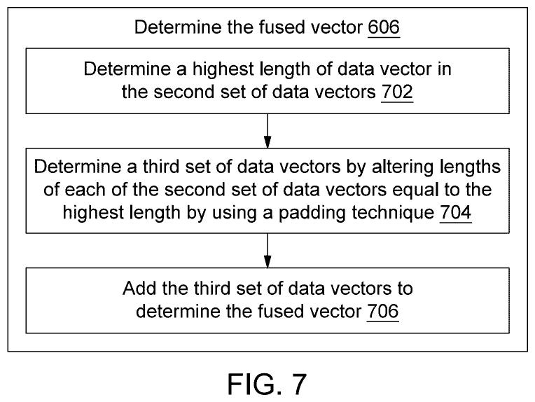

Referring now to FIG. 7, a flow diagram 700 of a methodology of determining a fused vector, is illustrated, in accordance with an embodiment of the present disclosure. FIG. 7 is explained in conjunction with FIG. 6. In an embodiment, the flow diagram 700 may include a plurality of steps that may be performed by various modules of the computing device 102 so as to determine the fused vector.

At step 702, a highest length of data vector may be determined in the second set of data vectors. Further at step 704, a third set of data vectors may be determined by altering lengths of each of the second set of data vectors equal to the highest length by using a padding technique. Further at step 706, the third set of data vectors may be added to determine the fused vector.

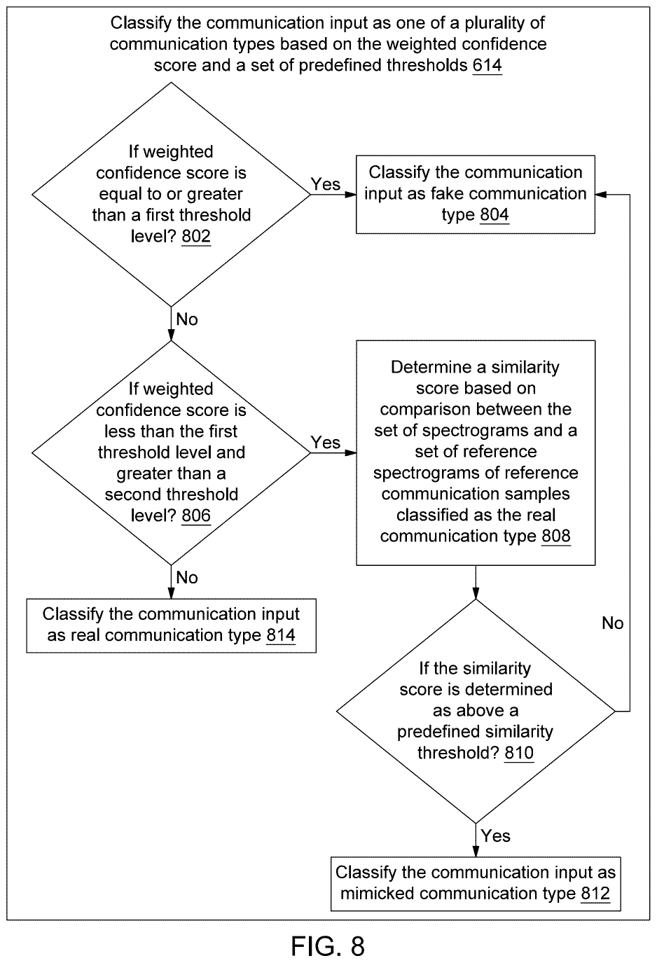

Referring now to FIG. 8, a flow diagram 800 of a methodology of classifying the communication input as one of a plurality of communication types, is illustrated, in accordance with an embodiment of present disclosure. FIG. 8 is explained in conjunction with FIG. 6. In an embodiment, the flow diagram 800 may include a plurality of steps that may be performed by various modules of the computing device 102 so as to classify the communication input as one of the plurality of communication types.

In order to classify the communication input as one of the plurality of communication types, the computing device 102, at step 802, may perform a check to determine if weighted confidence score is equal to or greater than a first threshold level. If the weighted confidence score is equal to or greater than the first threshold level, the computing device 102, at step 804, may classify the communication input as the fake communication type. However, if the weighted confidence score is not equal to or greater than the first threshold level, the computing device 102, at step 806, may further perform a check to determine if weighted confidence score is less than the first threshold level and greater than a second threshold level. If the weighted confidence score is less than the first threshold level and greater than the second threshold level, the computing device 102, at step 808, may determine a similarity score based on comparison between the set of spectrograms and a set of reference spectrograms of reference communication samples classified as the real communication type.

Upon determining the similarity score, the computing device 102, at step 810, may further perform a check to determine if the similarity score is determined as above a predefined similarity threshold. If the similarity score is determined as above the predefined similarity threshold, the computing device 102, at step 812, may classify the communication input as the mimicked communication type. However, if the similarity score is not determined as above the predefined similarity threshold, the computing device 102, at step 804, may classify the communication input as the false communication type.

Referring back to step 806, if the weighted confidence score is not less than the first threshold level and greater than the second threshold level, the computing device 102, at step 814, may determine the weighted confidence score as less than the second threshold level and in such a case, the computing device 102 may classify the communication input as the real communication type.

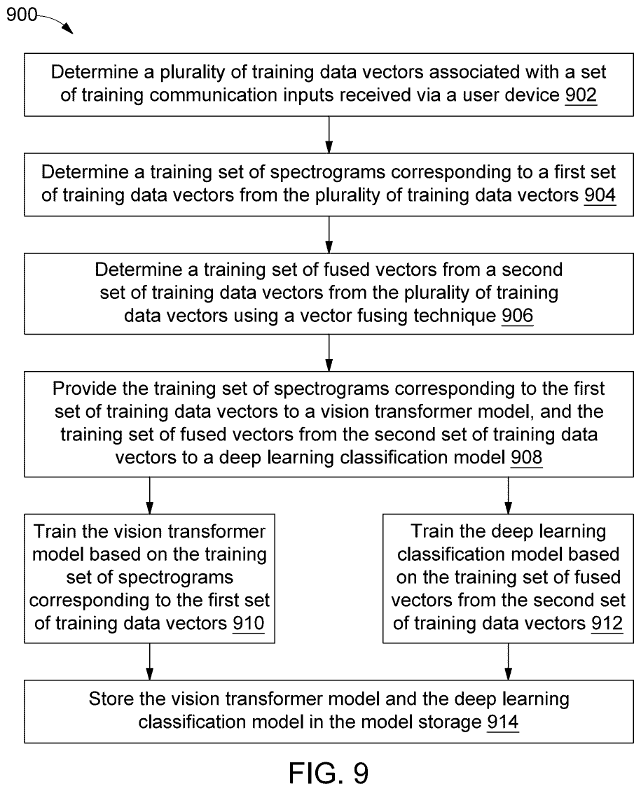

Referring now to FIG. 9, a flow diagram 900 of a methodology of training a vision transformation model and a deep learning classification model, is illustrated, in accordance with an embodiment of the present disclosure. In an embodiment, the flow diagram 900 may include a plurality of steps that may be performed by various modules of the computing device 102 so as to train the vision transformation model and the deep learning classification model.

At step 902, a plurality of training data vectors associated with a set of training communication inputs may be determined. In an embodiment, the set of training communication inputs may be indicated or provided by a user via the user device 116. Further at step 904, a training set of spectrograms corresponding to a first set of training data vectors may from the plurality of training data vectors may be determined. Further at step 906, a training set of fused vectors may be determined from the second set of training data vectors from the plurality of training data vectors using a vector fusion technique. Further at step 908, the training set of spectrograms corresponding to the first set of training data vectors may be provided to a vision transformation model and the training set of fused vectors from the second set of training data vectors may be provided to a deep learning classification model. Further at step 910, the vision transformer model may be trained based on the training set of spectrograms corresponding to the first set of training data vectors. Simultaneously at step 912, the deep learning classification model may be trained based on the training set of fused vectors from the second set of training data vectors. Thereafter at step 914, the vision transformation model and the deep learning classification model may be stored in the model storage 114.

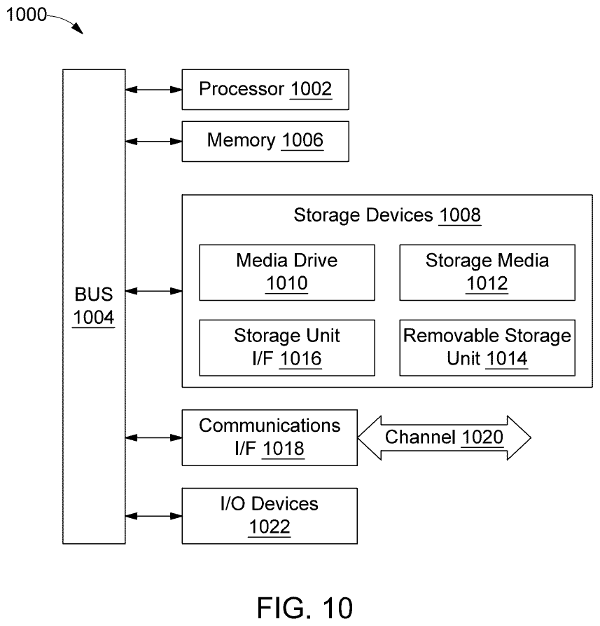

Referring now to FIG. 10, an exemplary computing system 1000 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1000 may represent, for example, a user device such as a desktop, a laptop, a mobile phone, personal entertainment device, DVR, and so on, or any other type of special or general-purpose computing device as may be desirable or appropriate for a given application or environment. The computing system 1000 may include one or more processors, such as a processor 1002 that may be implemented using a general or special purpose processing engine such as, for example, a microprocessor, microcontroller or other control logic. In this example, the processor 1002 is connected to a bus 1004 or other communication medium. In some embodiments, the processor 1002 may be an Artificial Intelligence (AI) processor, which may be implemented as a Tensor Processing Unit (TPU), or a graphical processor unit, or a custom programmable solution Field-Programmable Gate Array (FPGA).

The computing system 1000 may also include a memory 1006 (main memory), for example, Random Access Memory (RAM) or other dynamic memory, for storing information and instructions to be executed by the processor 1002. The memory 1006 also may be used for storing temporary variables or other intermediate information during execution of instructions to be executed by the processor 1002. The computing system 1000 may likewise include a read only memory (“ROM”) or other static storage device coupled to bus 804 for storing static information and instructions for the processor 1002.

The computing system 1000 may also include a storage device 1008, which may include, for example, a media drive 1010 and a removable storage interface. The media drive 1010 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1012 may include, for example, a hard disk, magnetic tape, flash drive, or other fixed or removable medium that is read by and written to by the media drive 1010. As these examples illustrate, the storage media 1012 may include a computer-readable storage medium having stored there in particular computer software or data.

In alternative embodiments, the storage devices 1008 may include other similar instrumentalities for allowing computer programs or other instructions or data to be loaded into the computing system 1000. Such instrumentalities may include, for example, a removable storage unit 1014 and a storage unit interface 1016, such as a program cartridge and cartridge interface, a removable memory (for example, a flash memory or other removable memory module) and memory slot, and other removable storage units and interfaces that allow software and data to be transferred from the removable storage unit 1014 to the computing system 1000.

The computing system 1000 may also include a communications interface 1018. The communications interface 1018 may be used to allow software and data to be transferred between the computing system 800 and external devices. Examples of the communications interface 818 may include a network interface (such as an Ethernet or other NIC card), a communications port (such as for example, a USB port, a micro-USB port), Near field Communication (NFC), etc. Software and data transferred via the communications interface 818 are in the form of signals which may be electronic, electromagnetic, optical, or other signals capable of being received by the communications interface 1018. These signals are provided to the communications interface 1018 via a channel 1020. The channel 1020 may carry signals and may be implemented using a wireless medium, wire or cable, fiber optics, or other communications medium. Some examples of the channel 1020 may include a phone line, a cellular phone link, an RF link, a Bluetooth link, a network interface, a local or wide area network, and other communications channels.

The computing system 1000 may further include Input/Output (I/O) devices 1022. Examples may include, but are not limited to a display, keypad, microphone, audio speakers, vibrating motor, LED lights, etc. The I/O devices 1022 may receive input from a user and also display an output of the computation performed by the processor 1002. In this document, the terms “computer program product” and “computer-readable medium” may be used generally to refer to media such as, for example, the memory 1006, the storage devices 1008, the removable storage unit 1014, or signal(s) on the channel 1020. These and other forms of computer-readable media may be involved in providing one or more sequences of one or more instructions to the processor 1002 for execution. Such instructions, generally referred to as “computer program code” (which may be grouped in the form of computer programs or other groupings), when executed, enable the computing system 1000 to perform features or functions of embodiments of the present invention.

In an embodiment where the elements are implemented using software, the software may be stored in a computer-readable medium and loaded into the computing system 1000 using, for example, the removable storage unit 1014, the media drive 1010 or the communications interface 1018. The control logic (in this example, software instructions or computer program code), when executed by the processor 1002, causes the processor 1002 to perform the functions of the invention as described herein.

Thus, the disclosed system 100 and method 600 overcome the challenges associated with conventional voice authentication and fraud detection techniques by leveraging a multi-modal deep learning approach for real-time detection of fake and mimicked voices. the disclosed system 100 and method 600 address the limitations of existing solutions by integrating spectrogram-based image analysis using a vision transformer model, along with text, voice, and emotional feature-based classification using a Long Short-Term Memory (LSTM) with Multi-Head Attention model. This dual-model architecture enhances accuracy by capturing both visual and linguistic features associated with real and fake communication inputs. In contrast to conventional voice authentication systems that primarily rely on signal processing techniques, the disclosed system 100 and method 600 introduces a fusion-based feature extraction mechanism that dynamically assigns weights to different feature sets. The disclosed system 100 and method 600 further performs spectrogram-based comparison between the input communication and a set of reference spectrograms of real voices. This additional validation ensures that mimicked voices, which closely resemble genuine user voices, are accurately classified. If the similarity score between the input spectrogram and reference spectrograms exceeds a predefined similarity threshold, the input is classified as mimicked rather than cloned (fake).

Furthermore, the disclosed system 100 and method 600 filters the communication input based on its classification. If the communication input is classified as real, it is processed without restriction. If classified as cloned (fake), it may be blocked or flagged for further verification. If classified as mimicked, the disclosed system 100 and method 600 may apply an additional validation step, such as requesting user authentication or matching voice patterns with historical data. The filtration mechanism enhances security against deepfake-based fraud, particularly in industries such as banking, telecommunications, and online identity verification. Thus, the disclosed system 100 and method 600 present a solution that combines real-time processing, deep learning-based classification, and adaptive filtration mechanisms to effectively detect and mitigate fake and mimicked voice-based fraud.

As will be appreciated by those skilled in the art, the techniques described in the various embodiments discussed above are not routine, or conventional, or well-understood in the art. The techniques discussed above provide for filtering reproduced communication in real-time.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described the system and method for filtering reproduced communication in real-time. The illustrated steps are set out to explain the exemplary embodiments shown, and it should be anticipated that ongoing technological development will change the manner in which particular functions are performed. These examples are presented herein for the purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It is intended that the disclosure and examples be considered as exemplary only, with a true scope of disclosed embodiments being indicated by the following claims.

What is claimed is:

1. A system for filtering reproduced communication in real time, comprising:
a processor; and
a memory communicably coupled to the processor, wherein the memory stores processor-executable instructions, which when executed by the processor, cause the processor to:
determine a plurality of data vectors associated with a communication input received via a user device;
determine a set of spectrograms corresponding to a first set of data vectors from the plurality of data vectors;
determine a fused vector from a second set of data vectors from the plurality of data vectors using a vector fusing technique;
determine a first confidence score based on an analysis of the set of spectrograms using a vision transformer model;
determine a second confidence score based on an analysis of the fused vector using a deep learning classification model;
determine a weighted confidence score based on the first confidence score, the second confidence score and corresponding predefined weights associated to the first confidence score and the second confidence score;
classify the communication input as one of a plurality of communication types based on the weighted confidence score and a set of predefined thresholds; and
filter the communication input received by the user device based on the classification.

2. The system of claim 1, wherein the plurality of data vectors corresponds to a set of voice features, a set of text feature, a set of emotional features, and a set of image features.

3. The system of claim 2, wherein the processor-executable instructions further cause the processor to:
determine the set of voice features based on Mel-frequency cepstral coefficients (MFCCs) of the communication input,
determine the set of text features based on conversion of audio information of the communication input to text information, wherein the set of text features comprises semantic information and linguistic information determined from the text information,
determine the emotional features based on the set of text features, and
determine the image features based on determination of a spectrogram representation of the set of voice features.

4. The system of claim 1, wherein the processor is configured to determine the fused vector based on:
determination of a highest length of data vector in the second set of data vectors;
determination of a third set of data vectors by altering lengths of each of the second set of data vectors equal to the highest length by using a padding technique; and
addition of the third set of data vectors to determine the fused vector.

5. The system of claim 1, wherein the vision transformer model is trained based on a training set of spectrograms corresponding to a set of training communication inputs of each of the plurality of communication types, and
wherein the deep learning classification model is trained based on a training set of fused vectors corresponding to the set of training communication inputs of each of the plurality of communication types.

6. The system of claim 1, wherein the plurality of communication types comprises a real communication type, a fake communication type, and a mimicked communication type,
wherein the communication input is classified as the fake communication type in case the weighted confidence score is equal to or greater than a first threshold level from the set of predefined thresholds,
wherein the communication input is classified as the mimicked communication type in case the weighted confidence score is less than the first threshold level and greater than a second threshold level from the set of predefined thresholds, and
wherein the communication input is classified as the real communication type in case the weighted confidence score is less than the second threshold level.

7. The system of claim 6, wherein upon determination of the weighted confidence score less than the first threshold level and greater than the second threshold level, the processor-executable instructions cause the processor to:
determine a similarity score based on comparison between the set of spectrograms and a set of reference spectrograms of reference communication samples classified as the real communication type,
wherein the communication input is classified as the mimicked communication type in case the similarity score is determined above a predefined similarity threshold.

8. A method of filtering reproduced communication in real-time, the method comprising:
determining, by a processor and in real-time, a plurality of data vectors associated with a communication input received via a user device;
determining, by the processor, a set of spectrograms corresponding to a first set of data vectors from the plurality of data vectors;
determining, by the processor, a fused vector from a second set of data vectors from the plurality of data vectors using a vector fusing technique;
determining, by the processor, a first confidence score based on an analysis of the set of spectrograms using a vision transformer model;
determining, by the processor, a second confidence score based on an analysis of the fused vector using a deep learning classification model;
determining, by the processor, a weighted confidence score based on the first confidence score, the second confidence score and corresponding predefined weights associated to the first confidence score and the second confidence score;
classifying, by the processor, the communication input as one of a plurality of communication types based on the weighted confidence score and a set of predefined thresholds; and
filtering, by the processor, the communication input received by the user device based on the classification.

9. The method of claim 8, wherein the plurality of data vectors corresponds to a set of voice features, a set of text feature, a set of emotional features, and a set of image features.

10. The method of claim 9, wherein:
the set of voice features are determined based on Mel-frequency cepstral coefficients (MFCCs) of the communication input,
the set of text features are determined based on conversion of audio information of the communication input to text information, wherein the set of text features comprises semantic information and linguistic information determined from the text information,
the emotional features are determined based on the set of text features, and
the image features are determined based on determination of a spectrogram representation of the set of voice features.

11. The method of claim 8, wherein the fused vector is determined by:
determining, by the processor, a highest length of data vector in the second set of data vectors;
determining, by the processor, a third set of data vectors by altering lengths of each of the second set of data vectors equal to the highest length by using a padding technique;
adding, by the processor, the third set of data vectors to determine the fused vector.

12. The method of claim 8, wherein the vision transformer model is trained based on a training set of spectrograms corresponding to a set of training communication inputs of each of the plurality of communication types, and wherein the deep learning classification model is trained based on a training set of fused vectors corresponding to the set of training communication inputs of each of the plurality of communication types.

13. The method of claim 8, wherein the plurality of communication types comprises a real communication type, a fake communication type, and a mimicked communication type,
wherein the communication input is classified as the fake communication type in case the weighted confidence score is equal to or greater than a first threshold level from the set of predefined thresholds,
wherein the communication input is classified as the mimicked communication type in case the weighted confidence score is less than the first threshold level and greater than a second threshold level from the set of predefined thresholds, and
wherein the communication input is classified as the real communication type in case the weighted confidence score is less than the second threshold level.

14. The method of claim 13, comprises:
upon determining the weighted confidence score less than the first threshold level and greater than the second threshold level:
determining, by the processor, a similarity score based on comparison between the set of spectrograms and a set of reference spectrograms of reference communication samples classified as the real communication type,
wherein the communication input is classified as the mimicked communication type in case the similarity score is determined above a predefined similarity threshold.

15. A non-transitory computer-readable medium storing computer-executable instructions for filtering reproduced communication in real-time, the computer-executable instructions configured for:
determining, in real-time, a plurality of data vectors associated with a communication input received via a user device;
determining a set of spectrograms corresponding to a first set of data vectors from the plurality of data vectors;
determining a fused vector from a second set of data vectors from the plurality of data vectors using a vector fusing technique;
determining a first confidence score based on an analysis of the set of spectrograms using a vision transformer model;
determining a second confidence score based on an analysis of the fused vector using a deep learning classification model;
determining a weighted confidence score based on the first confidence score, the second confidence score and corresponding predefined weights associated to the first confidence score and the second confidence score;
classifying the communication input as one of a plurality of communication types based on the weighted confidence score and a set of predefined thresholds; and
filtering the communication input received by the user device based on the classification.

16. The non-transitory computer-readable medium of claim 15, wherein the plurality of data vectors corresponds to a set of voice features, a set of text feature, a set of emotional features, and a set of image features.

17. The non-transitory computer-readable medium of claim 16, wherein:
the set of voice features are determined based on Mel-frequency cepstral coefficients (MFCCs) of the communication input,
the set of text features are determined based on conversion of audio information of the communication input to text information, wherein the set of text features comprises semantic information and linguistic information determined from the text information,
the emotional features are determined based on the set of text features, and
the image features are determined based on determination of a spectrogram representation of the set of voice features.

18. The non-transitory computer-readable medium of claim 15, wherein to determine the fused vector, the computer-executable instructions are configured for:
determining a highest length of data vector in the second set of data vectors;
determining a third set of data vectors by altering lengths of each of the second set of data vectors equal to the highest length by using a padding technique;
adding the third set of data vectors to determine the fused vector.

19. The non-transitory computer-readable medium of claim 15, wherein the vision transformer model is trained based on a training set of spectrograms corresponding to a set of training communication inputs of each of the plurality of communication types, and wherein the deep learning classification model is trained based on a training set of fused vectors corresponding to the set of training communication inputs of each of the plurality of communication types.

20. The non-transitory computer-readable medium of claim 15, wherein the plurality of communication types comprises a real communication type, a fake communication type, and a mimicked communication type,
wherein the communication input is classified as the fake communication type in case the weighted confidence score is equal to or greater than a first threshold level from the set of predefined thresholds,
wherein the communication input is classified as the mimicked communication type in case the weighted confidence score is less than the first threshold level and greater than a second threshold level from the set of predefined thresholds, and
wherein the communication input is classified as the real communication type in case the weighted confidence score is less than the second threshold level.
